(19) United States
(12) Patent Application Publication
(10) Pub. No.: US 2026/0067368 A1
(43) Pub. Date: Mar. 5, 2026

(54) MIDDLEWARE-BASED REAL-TIME FINE-GRAIN SENSING FOR SMART ELECTRICITY METERS

(71) Applicant: KING FAHD UNIVERSITY OF PETROLEUM AND MINERALS, Dhahran (SA)

(72) Inventors: Basem ALMADANI, Dhahran (SA); Abdullahi Sani SHUAIBU, Dhahran (SA); Sami UL HAQ, Khobar (SA); Farouq Muhammad ALIYU, Dhahran (SA)

(73) Assignee: KING FAHD UNIVERSITY OF PETROLEUM AND MINERALS, Dhahran (SA)

(21) Appl. No.: 18/825,947

(22) Filed: Sep. 5, 2024

(51) Int. Cl. H04L 67/125; H04L 12/28; H04W 52/02

(52) U.S. Cl. CPC H04L 67/125; H04L 12/2838; H04W 52/0274

(57) ABSTRACT

A sensor network for real-time monitoring of electric loads within a household includes multiple Smart Electricity Meter (SEM) processing boards mounted near electrical outlets. Each electrical appliance in the household connects to a corresponding SEM processing board, which receives actuator commands. The network also includes at least one subscriber processing circuitry positioned to subscribe to specific sensor data topics from these appliances, storing data and performing analysis of the sensor data to monitor electrical load of individual ones of electrical appliances. Each SEM processing board periodically monitors appliance sensor data, publishing any changes to an intermediate agent of a Data Distribution Service (DDS) processing circuitry located centrally in the household. The intermediate agent stores the published data and controls its transmission to the subscriber processing circuitry. The system ensures efficient data handling and analysis, enhancing real-time energy monitoring and management within the household.

### STATEMENT REGARDING PRIOR DISCLOSURE BY THE INVENTORS

Aspects of this technology are described in an article B. Almadani, A. S. Shuaibu, S. Ul Haq and F. Aliyu, “Realtime Middleware-based Distributed Micro-Smart Electricity Meters,” 2024 12th International Conference on Smart Grid (icSmartGrid), Setubal, Portugal, 2024, pp. 90-94. The article is herein incorporated by reference in its entirety.

### STATEMENT OF ACKNOWLEDGEMENT

The authors would like to acknowledge the support provided by the Deanship of Scientific Research (DSR) at King Fahd University of Petroleum & Minerals (KFUPM), Dhahran, Saudi Arabia, for supporting this work.

### BACKGROUND

### Technical Field

The present disclosure is directed to the field of smart grid technologies and, more specifically, to the communication and data management systems for Smart Electricity Meters (SEMs) within Smart Grids (SGs).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The global energy landscape refers to the overall state and dynamics of energy production, distribution, and consumption worldwide, including the transition from fossil fuels to renewable energy sources, advancements in energy technologies, and efforts to improve energy efficiency and sustainability. The global energy landscape is transforming rapidly with the advent of smart grids (SGs) and the integration of smart electricity meters (SEMs).

SEMs are digital devices connected to the internet that measure, record, and communicate utility consumption data, enabling real-time monitoring and more efficient management of utilities such as electricity, gas, or water usage. The SEMs replace traditional analog meters, and provide detailed feedback on energy consumption and supporting grid management. A SEM is a component of the Internet of Things (IoT) architecture, offering data for energy monitoring and grid improvement [See: Mocnej, J., Pekar, A., Seah, W. K., Papcun, P., Kajati, E., Cupkova, D., Koziorek, J., Zolotova, I.: Quality-enabled decentralized iot architecture with efficient resources utilization. Robotics and Computer-Integrated Manufacturing 67, 102001 (2021)]. Conventional analog meters are mechanical devices used to measure and record the amount of electricity consumed by a household or business. The conventional analog meters typically have a spinning disk and dials that display the consumption in kilowatt-hours (kWh). The spinning disk rotates at a speed proportional to the electricity usage, and the dials record the cumulative total. Utility personnel must manually read and record the data from these meters to generate bills, which is labor-intensive and prone to human error. Additionally, analog meters do not provide real-time data or support advanced grid management functions.

The adoption of SEMs in SGs facilitates two-way communication between energy producers and consumers, enhancing decision-making for both parties. Smart meters provide detailed feedback on energy consumption and support grid management by transmitting data automatically to utility companies, enabling two-way communication between energy producers and/or suppliers and consumers, and enhancing decision-making for both parties. The implementation of smart grids addresses power underutilization, optimizes electricity distribution, and reduces carbon emissions [See: Ramakrishnaprabu, G., Sathish, R., Devarajan, R., Loganathan, P., et al.: Intrusive energy management with advanced smart metering and monitoring using iot. In: 2022 4th International Conference on Inventive Research in Computing Applications (ICIRCA), pp. 359-364 (2022)]. Smart meters, implemented in the smart grid ecosystem, offer detailed feedback on electricity usage and the ability to automatically adjust demand-side trends to minimize energy costs. In regions with constrained electricity resources, smart meters serve as a mechanism to prevent grid-wide outages.

A typical SEM system comprises sensors, actuators, a microcontroller, and a transceiver. The sensors in SEMs measure various electrical parameters, such as current flow, electrical potential difference, power factor, frequency, and ambient temperature. These sensors ensure precise monitoring and management of electrical consumption. Actuators in SEMs, such as relays and switches, respond to control signals from the microcontroller, enabling the connection or disconnection of electrical loads to ensure efficient energy distribution and prevent overloads. For instance, a relay might disconnect non-essential loads during peak demand periods to balance the load and prevent outages.

The microcontroller serves as the central processing unit of the SEM, reading data from sensors, executing predefined algorithms, and making decisions based on the readings. For example, if the power factor sensor detects a low power factor, the microcontroller might adjust the load distribution to improve efficiency. It can transmit data to a user, such as customer or supplier, or control the actuators to manage the electrical supply. The transceiver in SEMs allows for bidirectional communication, sending data from the SEM to external systems and receiving instructions to facilitate real-time monitoring and control.

Various technologies facilitate data transmission from SEMs to centralized data collection points. RESTful APIs use standard internet protocols to enable data updates, allowing different systems to communicate over the Web by making requests and receiving responses [See: Kornienko, D., Mishina, S., Shcherbatykh, S., Melnikov, M.: Principles of securing restful api web services developed with python frameworks. In: Journal of Physics: Conference Series, vol. 2094, p. 032016 (2021)]. WebSockets provide real-time communication capabilities between client and server, maintaining an open connection for instant data exchange and reduced latency. Message Queuing Telemetry Transport (MQTT) is a lightweight messaging protocol designed for IoT applications that operates on a publish/subscribe model, where devices publish data to a broker, and interested subscribers receive the data [See: Palmese, F., Redondi, A. E., Cesana, M.: Adaptive quality of service control for mqtt-sn. Sensors 22(22), 8852 (2022)]. Despite these capabilities, the technologies have certain limitations, such as RESTful APIs require an internet connection, WebSockets lack Quality of Service (QoS) features, and MQTT's QoS policies are limited.

To address these limitations, an augmented publish/subscribe middleware solution has been adopted. This augmented middleware solution integrates the advantages of previous technologies while mitigating their shortcomings. The Data Distribution Service (DDS) publish/subscribe middleware (DPSM) is one communication mechanism for SEM systems, offering a data-centric approach to distributed applications, communication, and integration, and enhancing message transmission efficiency in mission-critical environments [See: OMG: OMG Data Distribution Service (DDS): Version 1.4”. Object Management Group (OMG), (2015)]. DPSM operates independently of the internet, ensuring robustness and reliability, and comes with preconfigured QoS policies to handle heavy traffic, providing an improvement to limitations in MQTT.

Various communication technologies, including power line communication (PLC) and wireless communication protocols, such as Long Range Wide Area Network (LoRaWAN), have been explored to enhance SEM performance. PLC uses existing power lines for data transmission, leveraging the infrastructure already in place for electrical distribution, reducing the need for additional wiring. However, PLC can be affected by electrical interference and noise, which may impact data reliability. LoRaWAN is a low-power, wide-area networking protocol designed for IoT applications, providing long-range communication capabilities with low power consumption, making it suitable for SEMs in remote or expansive areas. LoRaWAN operates in the unlicensed Industrial, Scientific, and Medical (ISM) bands, providing reliable communication despite environmental interference.

Research on improving the communication performance of SEMs aims to minimize latency and increase throughput in SG systems. SEMs can be designed for suppliers, consumers, or both, offering features like automatic billing systems and energy consumption monitoring. For example, SEMs designed for suppliers might include automated billing systems that streamline the billing process, reducing administrative costs and improving accuracy. Consumers' SEMs can provide detailed feedback on energy usage, helping users identify areas for energy savings and reducing overall consumption.

Despite the progress, challenges remain in implementing an efficient, cost-effective, and optimized SEM system. Existing technologies often focus on individual evaluations, such as the impact of demand response programs (DRPs) or net energy metering (NEM), without addressing the combined impact of these factors on SEM design. Existing technologies for data transmission and communication, such as RESTful APIs, WebSockets, and MQTT, exhibit significant drawbacks. These include the requirement for constant internet connectivity, insufficient Quality of Service (QoS) features, and limited QoS policies.

Thus, an object of the present disclosure is to provide an integrated system that combines a smart grid (SG) having renewable generation sources, energy storage devices, and demand response programs with net energy metering mechanisms to manage energy supply and demand effectively. A further object is to addresses the inefficiencies and limitations in the communication and data management of smart electricity meters (SEMs) within the smart grids.

### SUMMARY

In an exemplary embodiment, a sensor network of Smart Electricity Meter (SEM) processing circuitry for real-time monitoring of electric loads within a household is described. The sensor network includes a plurality of SEM processing boards mounted adjacent to electrical outlets of the household and a plurality of electrical appliances in the household, each appliance connected to respective ones of the plurality of SEM processing boards as publishers. Each SEM processing board is configured to receive an actuator command for a respective appliance. The sensor network further includes at least one subscriber processing circuitry mounted at locations in the household configured to subscribe to a topic for the sensor data of specific ones of the plurality of electrical appliances and perform data storage in a storage device and analysis on the sensor data. Each SEM processing board periodically monitors respective appliance sensor data and, when there is a change in the sensor data, publishes the sensor data for the topic to an intermediate agent of a Data Distribution Service (DDS) processing circuitry mounted at centralized locations in the household. The intermediate agent receives and stores the published sensor data for the topic. The intermediate agent is configured to control transmission of the sensor data for the topic to the at least one subscriber processing circuitry that subscribes to the topic.

In another exemplary embodiment, a method of real-time monitoring of electric loads of respective electrical appliances within a household, each of the plurality of electrical appliances connected to respective Smart Electricity Meter (SEM) processing boards which are mounted adjacent to electrical outlets in the household is described. The method includes periodically monitoring respective appliance sensor data and, when there is a change to the sensor data, publishing, by the respective SEM processing board, the sensor data to an intermediate agent of a Data Distribution Service (DDS) processing circuitry, which are mounted at centralized locations in the household. The method further includes subscribing, by at least one subscriber processing circuitry mounted in the household, to a topic for the sensor data of specific electrical appliances of the household, control the transmitting, by the intermediate agent, the sensor data to the at least one subscriber processing circuitry that subscribes to the topic, performing, by the subscriber processing circuitry, data storage in a storage device and analysis on the sensor data, and actuating an actuator upon receiving respective an appliance specific actuator command based on the analysis of the sensor data.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a DDS system in accordance with an exemplary aspect of the disclosure.

FIG. 2 is a taxonomy of smart electric meters, according to certain embodiments.

FIG. 3 illustrates a deployment configuration for implementing the SEM system, according to certain embodiments.

FIG. 4A is a diagram of a smart meter system, according to certain embodiments.

FIG. 4B is a block diagram of a SEM processing circuitry, according to certain embodiments.

FIG. 5A is a diagram of a plug-in module for the SEM processing circuitry, according to certain embodiments.

FIG. 5B is a diagram of a behind-wall module for the SEM processing circuitry, according to certain embodiments.

FIG. 6 is an exemplary prototype setup of the sensor network, according to certain embodiments.

FIG. 7 is an exemplary illustration of a latency profile of the sensor network, according to certain embodiments.

FIG. 8 illustrates a throughput profile of the sensor network, according to certain embodiments.

FIG. 9 is an exemplary schematic diagram of a data processing system used within the computing system, according to certain embodiments.

FIG. 10 is an exemplary schematic diagram of a processor used with the computing system, according to certain embodiments.

FIG. 11 is an illustration of a non-limiting example of distributed components which may share processing with the controller, according to certain embodiments.

FIG. 12 illustrates various distributed components of the computing system, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a sensor network of smart electricity meters (SEMs) designed for real-time fine-grain sensing of electric loads within a household. The proposed system leverages a data distribution service (DDS) publish/subscribe middleware (DPSM) to enhance communication efficiency. The sensor network includes SEMs connected to various household appliances to measure their power consumption. These measurements are transmitted to a server for storage and data analysis. The communication pathway is established using a microcontroller as the publisher and a server as the subscriber. This middleware-based solution demonstrates significant potential for real-time monitoring of power consumption of the household appliances in smart grid (SG) environments, contributing to the optimization of data transmission processes.

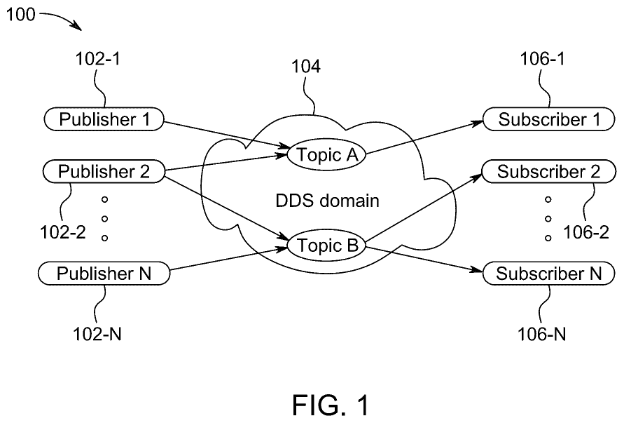

FIG. 1 illustrates a data distribution service (DDS) publish/subscribe middleware (DPSM) system 100 for efficient communication in smart electricity meters (SEMs). The DDS publish/subscribe middleware system, also referred to as the system 100, includes a plurality of components interconnected to ensure the robust and scalable transmission of data within the smart grid environment.

The system 100 includes, but may not be limited to, multiple publishers (102-1 to 102-N) and subscribers (106-1 to 106-N) communicating within a DDS domain 104. The publishers (102-1 to 102-N) represent the SEMs that publish data on specific topics within the DDS domain 104. The subscribers (106-1 to 106-N) are the data collection points that subscribe to these topics to receive the published data. Topics can include current, voltage, frequency, or temperature based on types of sensors.

The publishers (102-1 to 102-N) are the SEMs that monitor and publish data on various electrical parameters, such as voltage, current, and power consumption. For example, Publisher 1 (102-1) might be a SEM attached to a household refrigerator, continuously measuring and publishing data related to its power usage under Topic A. Publisher 2 (102-2) could be another SEM connected to a washing machine, publishing similar data under Topic B. The publishers ensure real-time data availability for different appliances within the household, and communication between the publishers and subscribers is independent of the specific protocols employed, providing a flexible and efficient data distribution mechanism.

Subscribers (106-1 to 106-N) act as data collection points that subscribe to specific topics published by the SEMs. Subscriber 1 (106-1) could be a server located at a central data collection point, which subscribes to Topic A, including refrigerator current, voltage, to receive power consumption data from the refrigerator. Subscriber 2 (106-2) might be another server dedicated to monitoring data from the washing machine under Topic B, including washing machine current, voltage. These subscribers aggregate the published data for storage, analysis, and further processing, such as determining patterns in energy consumption.

The DDS domain 104 facilitates the communication between these publishers and subscribers. The DDS domain 104 supports a data-centric approach, which means the focus is on the data itself rather than the communication protocols. The DDS domain 104 delineates APIs, behaviors, and Quality of Service (QoS) standards that significantly improve the performance of message transmission within mission-critical environments.

Thus, the DDS domain 104 ensures that all nodes within the network have a consistent view of the data, which is crucial for real-time monitoring and control. Unlike traditional message-centric middleware, the data-centric nature of DDS facilitates efficient and reliable data exchange in distributed systems.

The DDS domain 104 is equipped with a comprehensive set of Quality of Service (QoS) policies. These policies provide fine-grained control over various aspects of data communication, such as reliability, durability, latency, and resource usage. The QoS policies ensure that the system meets the specific requirements of smart grid applications, thereby optimizing performance.

The DDS domain 104 is designed for scalability, capable of dynamically scaling to accommodate the varying needs of smart grid applications. Whether dealing with a small number of devices or a vast network of sensors and meters, the DDS ensures efficient and reliable communication. The scalability of the DDS domain allows it to seamlessly adapt to the growing demands of smart grid environments.

As a result, the system 100 can seamlessly and dynamically scale to meet the requirements of smart grid applications, ensuring real-time monitoring and management of energy consumption.

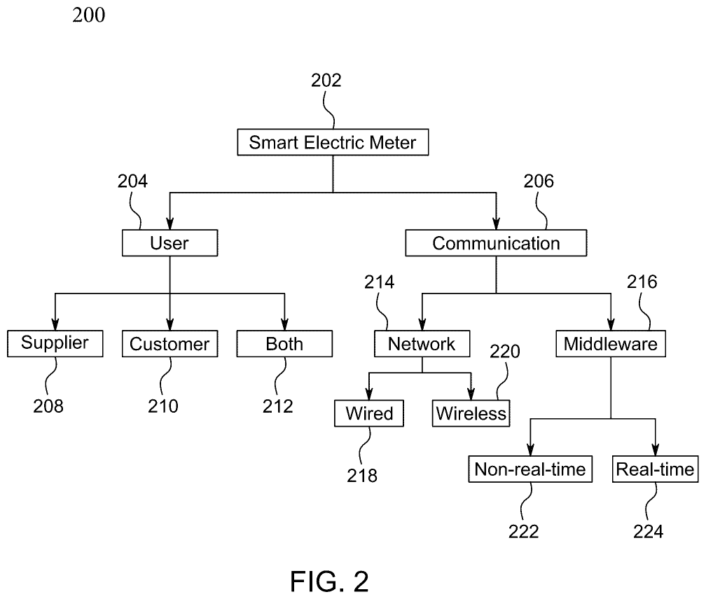

FIG. 2 illustrates a classification 200 for the SEMs, in accordance with one embodiment. The classification 200 classifies SEMs by user and communication.

The system 200 categorizes SEMs based on the user type 204 and communication technologies 206. SEMs can be designed for different types of users 204, including suppliers 208, customers 210, or both 212. SEMs for suppliers 208 offer automatic billing systems where users pay their electricity bills and automatically receive energy for the paid amount.

SEMs for suppliers are designed to facilitate the automatic billing process, ensuring users pay their electricity bills and automatically receive energy for the paid amount. For example, a utility company can deploy SEMs to monitor electricity usage across multiple households and businesses, streamlining the billing process and ensuring timely payments. SEM, thus, simplifies the billing process by eliminating manual meter readings and reducing the risk of human error, thereby ensuring accurate billing and timely energy provision.

SEMs for customers allow users to monitor their energy consumption habits or troubleshoot their wiring. For instance, residential users can install SEMs to gain insights into their daily energy usage patterns, helping them identify peak consumption periods and potential energy wastage. This information empowers customers to manage their energy consumption more effectively, potentially reducing their energy bills and promoting more sustainable energy usage. Additionally, SEMs can alert users to electrical issues within their homes, such as faulty wiring or appliances that consume excessive energy, enabling proactive maintenance and repairs.

Some SEMs offer services to both suppliers and customers, providing a comprehensive solution for energy management that benefits both parties. For example, a smart grid system might deploy SEMs that enable utility companies to manage energy distribution efficiently while also providing end-users with real-time feedback on their energy consumption. Such dual functionality supports better energy management, reduces overall energy consumption, and promotes a more balanced and efficient energy grid.

In terms of communication, SEMs can utilize various network technologies 214 and middleware solutions 216. The network can be either wired 218 or wireless 220.

Wired communication technologies 218 include the power line carrier (PLC), which uses existing power lines for data transmission. PLC technology leverages the existing electrical infrastructure, reducing the need for additional wiring. However, PLC can be affected by electrical interference and noise from other devices on the power line. An example of PLC technology is the G3-PLC, which is designed for smart grid applications, offering robust and reliable communication over power lines despite noise and signal attenuation.

Another wired communication technology 218 is Ethernet, which provides high-speed, reliable data transmission over local area networks (LANs). Ethernet is commonly used in industrial and commercial settings where robust and secure communication is essential. For instance, industrial facilities might use Ethernet-connected SEMs to monitor and control energy usage across various machines and equipment, ensuring optimal energy efficiency and operational reliability.

Wireless communication technologies 220, such as Long Range Wide Area Network (LoRaWAN), offer more reliable communication by providing low-power, long-range connectivity suitable for IoT systems. LoRaWAN operates in unlicensed ISM bands and is resistant to interference, making it ideal for environmental monitoring and smart grid applications. For example, LoRaWAN can be used to connect SEMs in remote or rural areas where wired communication infrastructure is impractical or too costly to deploy. LoRaWAN's ability to provide long-range communication with low power consumption ensures that SEMs can operate efficiently for extended periods without frequent maintenance or battery replacements.

Other wireless technologies 220 include, but may not be limited to, Zigbee and Wi-Fi. Zigbee is a low-power, low-data-rate wireless communication technology designed for home automation and energy management systems. Wireless communication 220 enables seamless communication between SEMs and other smart home devices, such as smart thermostats and lighting systems, facilitating integrated energy management solutions. Wi-Fi, on the other hand, provides high-speed wireless communication suitable for urban and suburban areas with established Wi-Fi infrastructure. Wi-Fi-enabled SEMs can easily connect to existing home or office networks, providing users with real-time access to their energy consumption data via smartphones, tablets, or computers.

Middleware 216 can be classified into non-real-time communication technologies 222 and real-time communication technology 224. Non-real-time communication technologies 222 do not require instant data transmission, making them suitable for applications where data can be collected and processed later. Real-time communication 224, on the other hand, ensures immediate data exchange, which is required for mission-critical environments where timely data processing and response are essential.

The SEM system 200 illustrates different SEM designs and technologies that have been implemented conventionally to improve smart grid (SG) performance. In an example, a wireless SEM based on the ESP32 microcontroller is implemented which simplifies hardware by performing calculations directly on the microcontroller and provides wireless connectivity for remote data transmission.

Various communication technologies have been developed to enhance SG performance. The PLC technology, for example, uses existing power lines for data transmission but suffers from short-term interruptions and higher overall reliability issues. Wireless technologies, such as LoRaWAN, offer more reliability and are less susceptible to interference from electrical devices, background noise, signal attenuation, and unknown line impedances. Other technologies, such as orthogonal frequency division multiplexing (OFDM) have been proposed for data transmission along transmission lines, offering resistance to interference and attenuation but requiring energy-saving strategies due to their high energy consumption.

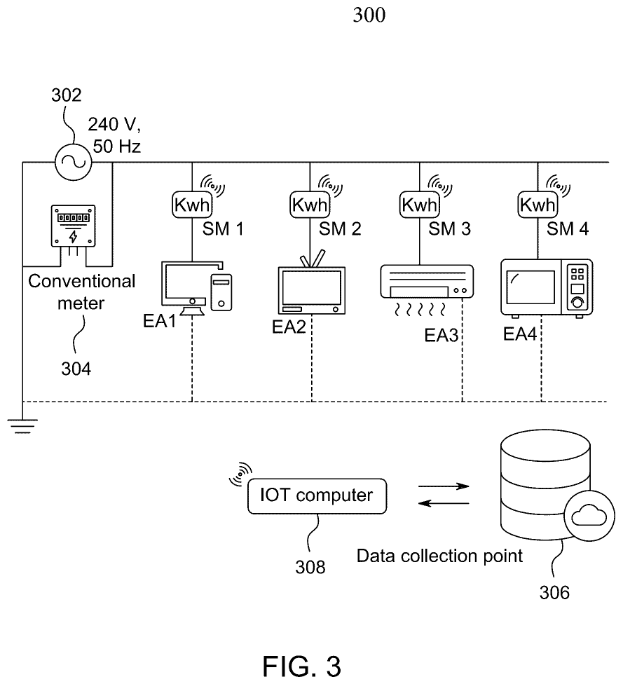

FIG. 3 illustrates a deployment configuration for implementing the SEM system 300 in a household equipped with various standard appliances. The SEM system 300, includes, but may not be limited to, a conventional meter 304, smart meters (SM 1, SM 2, SM 3, SM 4), an IoT computer 308, and a data collection point 306.

The system 300 is connected to main power supply 302. In one aspect, the power supply supplies a 240 V, 50 Hz. The conventional meter 304 measures the overall power consumption of the entire household. In addition to overall consumption being measured by the conventional meter 304, the system 300 implements a plurality of individual smart meters (SM 1, SM 2, SM 3, SM 4) to measure the power consumption of specific electrical appliances (EA1, EA2, EA3, EA4).

Each of the plurality of smart meters (SM 1, SM 2, SM 3, SM 4) is associated with an electrical appliance. For instance, SM 1 is connected to a computer system (EA1), SM 2 to a television (EA2), SM 3 to an air conditioner (EA3), and SM 4 to a microwave oven (EA4). These smart meters provide real-time readings of the power consumption of each appliance.

The real-time readings from the smart meters are transmitted to a centralized data collection point 306. The data collection point 306 comprises an IoT computer 308 and a shared database. The IoT computer 308 facilitates the communication between the smart meters and the data collection point, ensuring that the data is collected, processed, and stored efficiently.

The approach illustrated in FIG. 3 deviates from traditional methods by focusing on the monitoring the individual power consumption of each appliance rather than the overall household consumption. The system 300 enhances the granularity of energy monitoring, allowing for more precise management of energy usage and facilitating better communication between electricity consumers and producers.

A SEM system provides real-time monitoring of electric loads within a household. The system is connected to mains and includes a smart electricity meter.

A smart electricity meter, also referred to as a smart meter, is a metering device that records electrical energy consumption and communicates the information to the utility for monitoring and billing purposes. Unlike traditional analog meters, smart meter enables two-way communication between the meter and the central system. This functionality allows for real-time data collection, remote meter reading, and enhanced energy management. The smart electricity meter includes a SEM processing board.

The SEM processing board is an integral component of the smart electricity meter, configured for monitoring and managing the energy consumption of connected electrical appliances. The SEM processing board includes at least one micro-meter that measures the power consumption of the connected electrical appliance. The SEM is pluggable into a respective electrical outlet.

The micro-meter includes a current sensor and analog-to-digital converter (ADC), positioned in series with the respective appliance, to measure analog current, which is then converted to digital using the ADC.

Current sensors are devices that detect and measure the flow of electric current in a circuit and convert this measurement into a corresponding output signal. There are various types of current sensors, including hall effect sensors, shunt resistors, and Rogowski coils, each with its specific applications and benefits. The current sensors are widely used in industrial applications due to their accuracy and ability to measure both AC and DC currents. For example, a hall effect sensor could be used in a smart electricity meter to measure the current drawn by a washing machine. In another example, shunt resistors, also known as current shunts, measure current by detecting the voltage drop across a low-resistance element placed in series with the load. The voltage drop is directly proportional to the current flowing through the resistor, allowing for precise current measurement.

The ADC converts the analog voltage signal from the current sensor into a digital format that can be processed by microcontrollers or other digital systems. For example, in a smart electricity meter, an ADC might convert the analog signal from a hall effect sensor measuring the current drawn by a refrigerator into a digital signal. The digital signal can then be processed by a microcontroller to calculate the power consumption of the refrigerator, enabling real-time monitoring and energy management.

The current sensors and the ADC positioned in series allows for precise measurement of power consumption of the appliance in real-time. For instance, a micro-meter might measure the current drawn by a refrigerator, converting the analog signal to a digital format for further processing.

The electrical appliances monitored using SEM processing boards represent various household devices with diverse power consumption patterns and needs. The household smart meter system can be configured to monitor and control the power consumption patterns and needs of household appliances.

As an example, Electrical Appliance 1 ( ) may be a refrigerator, an essential household appliance that operates continuously to maintain the necessary cooling environment for food preservation. Monitoring the power consumption of a refrigerator allows for the analysis of its efficiency and operational patterns, providing insights into performance and potential areas for energy savings for the refrigerator. By tracking its power usage, users can identify any anomalies indicating possible malfunctions, such as a failing compressor or door seal issues, which could lead to increased energy consumption.

Electrical Appliance 2 may be a washing machine, a device that operates intermittently based on a laundry schedule of the household. By monitoring the power usage of a washing machine, users can obtain data of power usage by the washing machine and corresponding electricity rates. Using the data and electricity rates, the user can optimize laundry schedules to align with periods of lower electricity rates, thereby reducing energy costs. Additionally, analysis of the power consumption patterns of the washing machine can be used in detecting overloading or mechanical issues that might affect its efficiency.

Electrical Appliance 3 could be an air conditioning unit, known for its significant power consumption, especially during peak summer months. Monitoring the power usage of an air conditioning unit is crucial for managing overall energy consumption of the household and reducing the peak load impact on the electrical grid. By obtaining the power usage data, the data can be analyzed in order to implement strategies, such as automatically adjusting the thermostat settings, scheduling maintenance, or upgrading to more energy-efficient models to improve overall energy efficiency.

An electrical appliance could be a charge station for an electric vehicle. The charge station can be augmented with a smart electricity meter processing circuitry to provide data on electricity usage during charging of the electric vehicle. Monitoring the power usage of the charging station can be used to control operation of the charge station to minimize the cost of charging an electric vehicle. Also, the monitoring of the power usage of the charging station can be used to increase or decrease priority of charging an electric vehicle vs. power usage by other household appliances.

By utilizing SEM processing boards to monitor the household electrical appliances, households can achieve real-time insights into their energy usage patterns, and automatically perform energy management and conservation.

In one aspect, power connectors are implemented to connect the electrical appliances to the SEM processing boards. The power connectors facilitate the measurement of power consumption by the micro-meters. For example, power connectors can be configured to plug directly into standard electrical outlets, providing means of integrating the SEM processing boards with household appliances.

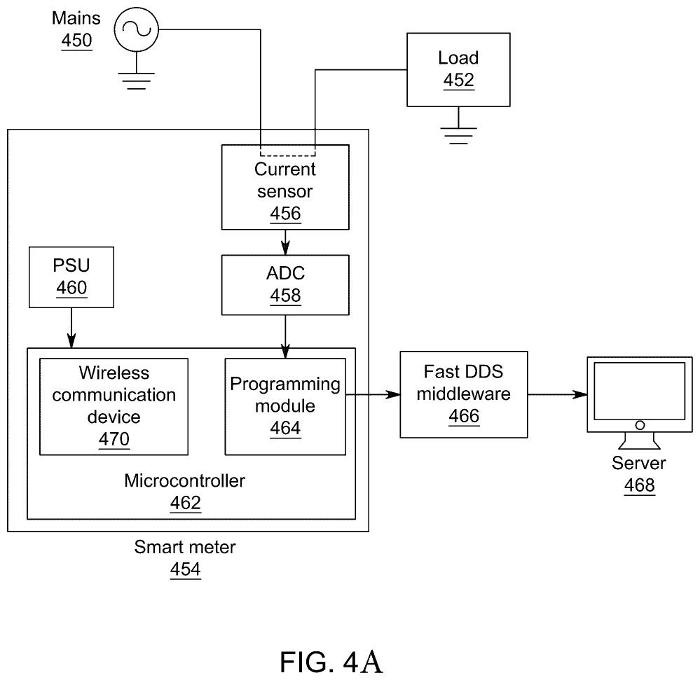

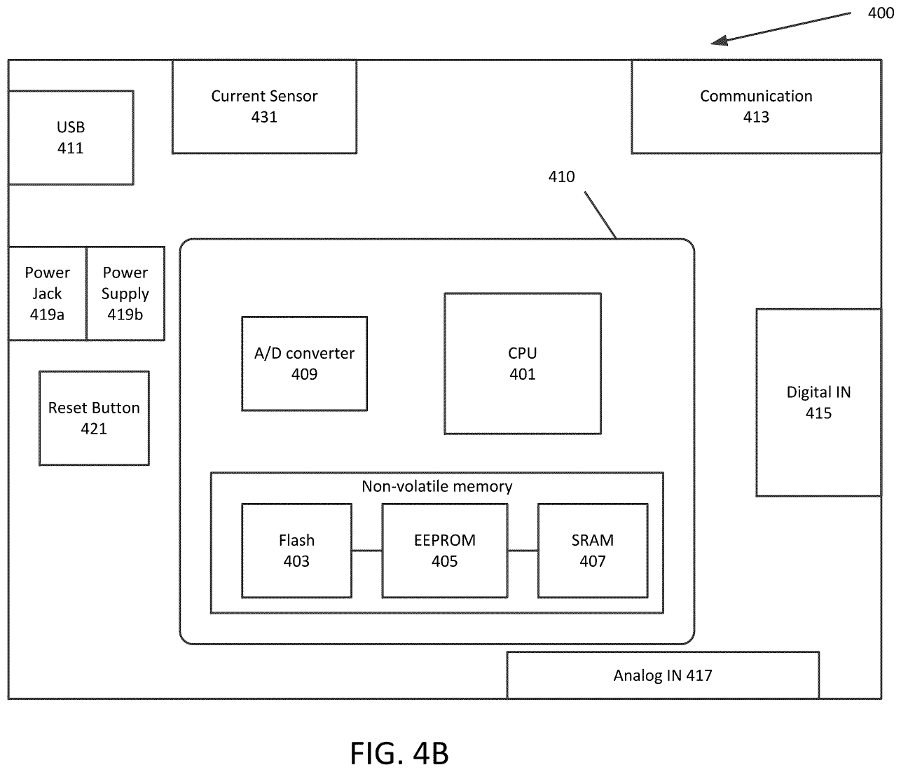

FIG. 4A is a diagram of a smart meter system. This diagram shows a single smart meter and a single server for simplicity. It should be understood that a smart meter system for a household will include several smart meters for household appliances and other electrical powered devices and more than one server. A server can be any device that is configured to subscribe to household sensor data. Each of the SEM processing boards, as shown in FIG. 4A, includes a microcontroller 462 configured to read the digital current and a wireless communication device 470 configured to either transmit the current reading to a user device or use the current reading to make decisions. The microcontroller 462 is configured with program instructions to collect the digital current reading and calculate actual power usage. The microcontroller 462 is also configured to make a decision to cut off power supply to a respective electrical appliance through an actuator command. For example, the microcontroller may cut off power to a washing machine during peak usage times to prevent overloading the grid. In another example, the microcontroller can determine a time to turn on power to specific appliances at appropriate time periods.

The intermediate agent 466 of the DDS processing circuitry is mounted at centralized locations in the household. The intermediate agent 466 is a component configured to receive and store the published sensor data for the topic and controls the transmission of the sensor data for the topic to at least one subscriber processing circuitry 410 that subscribes to the topic. The intermediate agent 466 manages communication functions of the DDS and ensures reliable data transmission and reception within the household sensor network. For example, the intermediate agent 466 can prioritize critical sensor data to ensure timely delivery to the subscriber processing circuitry 468.

The subscriber processing circuitry 468 performs data storage in a storage device and analysis on the sensor data. The subscriber processing circuitry 468 subscribes to specific topics related to the sensor data from the electrical appliances and uses the data for various analyses, such as identifying patterns in energy consumption, diagnosing potential issues with appliances, and optimizing energy usage. For example, the subscriber processing circuitry 468 might analyze data from multiple appliances to identify overall household energy usage trends. The subscriber processing circuitry 468 can include one or more mobile device configured with a software application to monitor, analyze, and administer control of household power usage of particular appliances.

The storage device is implemented to store the sensor data collected by the subscriber processing circuitry. This data can be used for historical analysis, reporting, and further optimization of energy consumption patterns. For example, the storage device can retain data over extended periods, allowing for long-term analysis of energy consumption trends.

The smart meter system includes a smart meter 454 connected to mains 450 and measuring the load 452.

The smart meter 454 is configured for measuring and communicating the power consumption of a connected electrical appliance. The smart meter 454 includes a current sensor 456, an analog-to-digital converter (ADC) 458, a power supply unit (PSU) 460, a microcontroller 462, and a programming module 464.

The current sensor 456 is positioned in series with the load 452 to measure the analog current drawn by the load. For example, the current sensor 456 can detect the current used by a connected appliance, such as an air conditioner, providing real-time data on its power consumption.

The ADC 458 converts the analog current measured by the current sensor 456 into a digital signal that can be processed by the microcontroller 462, in one example the microcontroller 462 is Raspberry Pi microcontroller. The analog to digital conversion is performed for accurate digital representation and subsequent analysis of the power consumption. The PSU 460 provides the necessary power for the operation of the smart meter 454 and its components. It ensures that the smart meter remains functional and can continuously monitor and report power consumption data.

In the example setup, the Raspberry Pi 462 runs the programming module 464 to process the digital current readings. The Raspberry Pi 462 is configured to perform calculations, control the power supply, and manage communication with external devices.

The programming module 464, running on the Raspberry Pi 462, includes a programming module 464 that interfaces with the ADC 458 and processes the current data. The programming module 464 calculates the actual power usage of the load 452 and communicates this information to external devices via a wireless communication device 470.

The wireless communication device 470 enables the smart meter 454 to communicate with external systems, such as a server 468. It uses various wireless communication protocols, including ZigBee, Wi-Fi, and Bluetooth, to transmit data efficiently. This allows for real-time monitoring and control of the connected load 452.

The fast DDS middleware 466 facilitates communication between the smart meter 454 and the server 468. It uses the real-time publish-subscribe (RTPS) protocol to ensure efficient and reliable data transmission. The middleware 466 manages the data flow, prioritizing critical information and maintaining the integrity of the communication process.

The server 468 receives the data transmitted by the smart meter 454 via the fast DDS middleware 466. The server 468 stores and analyzes the data, providing insights into power consumption patterns and enabling remote monitoring and control of the load 452. For example, the server 468 can alert users to unusual power consumption patterns, suggesting potential issues with the connected appliance.

FIG. 4B is a block diagram of a SEM processing circuitry. The smart meter 454 may be based on a microcontroller. A microcontroller may contain one or more processor cores (CPUs) along with memory (volatile and non-volatile) and programmable input/output peripherals. Program memory in the form of flash, ROM, EPROM, or EEPROM is often included on chip, as well as a secondary RAM for data storage. In one embodiment, the SEM processing circuitry 454 is an integrated circuit board with a microcontroller 410 and current sensor 431 mounted thereon. The board includes 54 digital I/O pins 415, 16 analog inputs 417, 4 communication module 413, a USB connection 411, a power jack 419a with power supply unit 419b, and a reset button 421. It should be understood that other microcontroller configurations are possible. Variations can include the number of pins, whether or not the board includes communication ports or a reset button.

The microcontroller may be a 8-bit AVR RISC-based microcontroller having 256 KB flash memory 403, 8K SRAM 407, 4 KB EEPROM 405, 86 general purpose I/O lines, 32 general purpose registers, a real time counter, six flexible timer/counters, a 16-channel 10-bit A/D converter 409, and a JTAG interface for on-chip debugging. The microcontroller is a single SOC that achieves a throughput of 16 MIPS at 16 MHz and operates between 4.5 to 5.5 volts. The recommended input voltage is between 7-12V. Although the description is of a particular microcontroller product, it should be understood that other microcontrollers may be used. Microcontrollers vary based on the number of processing cores, size of non-volatile memory, the size of data memory, as well as whether or not it includes an A/D converter or D/A converter.

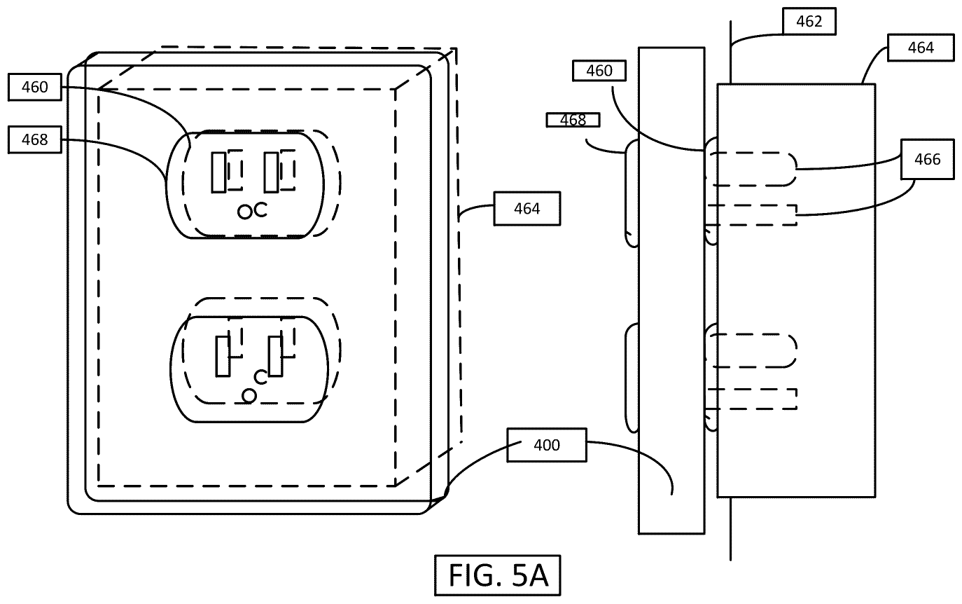

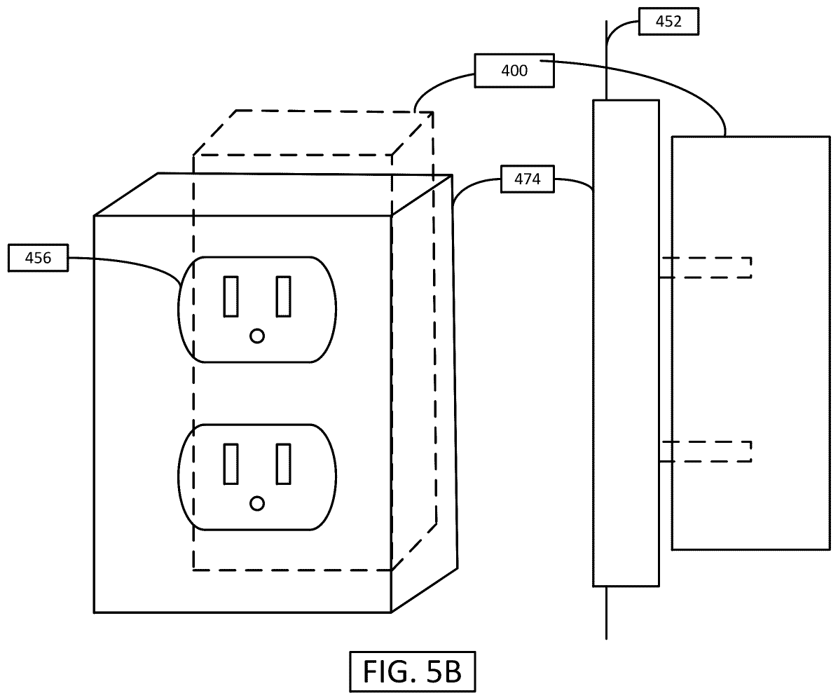

FIG. 5A is a diagram of a plug-in module for the SEM processing circuitry. In an embodiment, the SEM processing circuitry can be configured as a plug-in module that is encapsulated in an electrically insulated container. The insulated container may be box-shaped, dome-shaped, or cylindrical-shaped. In an embodiment, the insulated container may have surface dimensions that are larger than a regular outlet face plate, with a projection efficient height that is substantially the height of the SEM processing circuitry. Line 462 represents the outer surface of a wall.

The plug-in module 400 can be configured with either one or two external facing electrical outlets 468 and may be pluggable, via internal facing prongs 466, into single or double wall outlets 460. The configuration with one external facing electrical outlet does not block a second wall outlet. The configuration with two external facing outlets can enable connection with two appliances. In an embodiment, one of two external facing electrical outlets may be directly connected to a wall outlet providing a conventional electrical power outlet without a connection to the SEM. The circuit board containing the SEM may be positioned behind the external facing electrical outlets. Alternatively, the circuit board containing the SEM may be arranged in an adjacent side of the plug-in module that is aside from the electrical outlets 468. The wall outlets 460 may be an interface to a standard electrical box 464. The wall outlets 460 may be for a 110V outlet or alternatively for a 220V outlet for high power appliances such as electric dryer or microwave. A special wall outlet may be used in the case of a special device, such as for an electric vehicle charging station. In such cases, the plug-in module 400 may take on different configurations and power depending on type of electrical outlet. In one embodiment, the plug-in module 400 may be configured with a USB socket for direct connection with the circuit board for the SEM via USB cable.

In some embodiments, an indicator light may be included in the plug-in module to indicate the on or off status of the SEM processing circuitry, another indicator light to indicate status of communication, such as whether communication is currently active, and another indicator light to indicate that the respective plugged in appliance is configured for monitoring by the SEM processing circuitry. In some embodiments, the plug-in module may include a reset button as an interface to the reset function of the smart electronic meter.

FIG. 5B is a diagram of a behind-wall module for the SEM processing circuitry. In an embodiment, new homes or other households may be constructed with SEMs mounted inside of walls, with an outer interface 474 that resembles a conventional wall plate, configured with one or more electrical outlets 456. In some embodiments, one indicator light may be included in the outer interface to indicate the on or off status of the SEM processing circuitry behind a wall, and another indicator light to indicate communication status of the SEM processing circuitry. As in FIG. 5B, the SEM processing circuitry 400 may be configured in a electrical box configuration located behind a wall 452. In the case of a SEM processing circuitry for an electric vehicle charging station, the behind-wall module may be integrated with control circuitry for dispensing power, including automatic shut-off, power regulation circuitry.

In an embodiment, the plug-in module and the behind-wall module can be configured to detect and configure for a specific appliance. Once plugged in, an appliance can be associated with the specific appliance, by way of, for example, a mobile application. Once associated, monitoring software for the specific appliance can be installed in the microcontroller 462 via programming module 464. A smart meter 454 can be updated with new control software via the server 468, as necessary. When a different appliance is plugged into the plug-in module or outlet having a behind-wall outlet, the microcontroller 462 can be re-configured for the different appliance.

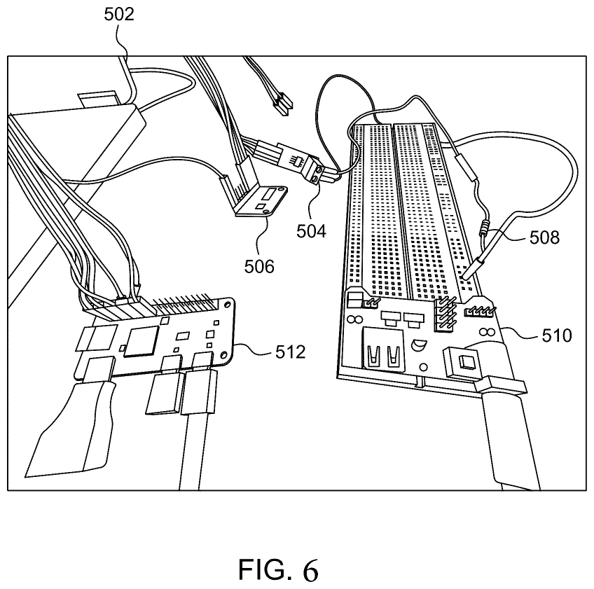

FIG. 6 illustrates a setup for a sensor network of the SEM processing circuitry for real-time monitoring of electric loads within a household, in accordance with one embodiment. The setup includes subscriber/server 502 configured for receiving and processing data published by the sensor nodes within the network. In one example, the subscriber/server 502 is equipped with a high-performance Core i7-5th generation processor clocked at 2.60 GHz, operating within an operating system, such as Windows 11 environment. 16 GB memory capacity of the server ensures seamless handling of incoming data streams. Connectivity options include both LAN and WiFi at 100 Mbps, providing versatile communication capabilities. The server acts as a hub for data storage, analysis, and control functions within the smart metering system.

The current sensor 504 is positioned in series with the load 508 to measure the analog current drawn by the load. The Analog-to-Digital Converter (ADC) 506 converts the analog signal from the current sensor 504 into a digital format.

The load 508 represents the electrical appliance or device being monitored for power consumption. In this experimental setup, the load can vary, including devices, such as light bulbs, fans, or other household appliances. The load 508 is connected to the current sensor 504 and the power supply 510 to enable continuous monitoring of its power usage. The power supply 510 provides the necessary electrical power to the entire experimental setup, including the current sensor 504, ADC 506, and the microcontroller 512, such as Raspberry Pi (Sensor Node).

The Raspberry Pi (Sensor Node) 512 serves as the primary processing unit in the experimental setup 500. It is equipped with an ARM6 single-core processor running at 700 MHz and operates on the headless Raspbian OS. The Raspberry Pi 512 has a memory capacity of 512 MB and connects to the network via WiFi. The Raspberry Pi 512 collects data from the ADC 506, processes it using a Python script, and publishes the data to the subscriber/server 502 using the fast DDS middleware. In this arrangement, the fast DDS middleware is installed in the subscriber/server 502. It should be understood that the fast DDS middleware can be installed in a separate hardware device. Also, although the experimental setup is for a single subscriber/server 502, the fast DDS middleware can handle multiple subscribers/servers. Further, it should be understood that the load for a household may consist of several sensor nodes. As such, a household may include many sensor nodes, a fast DDS middleware device, and several servers.

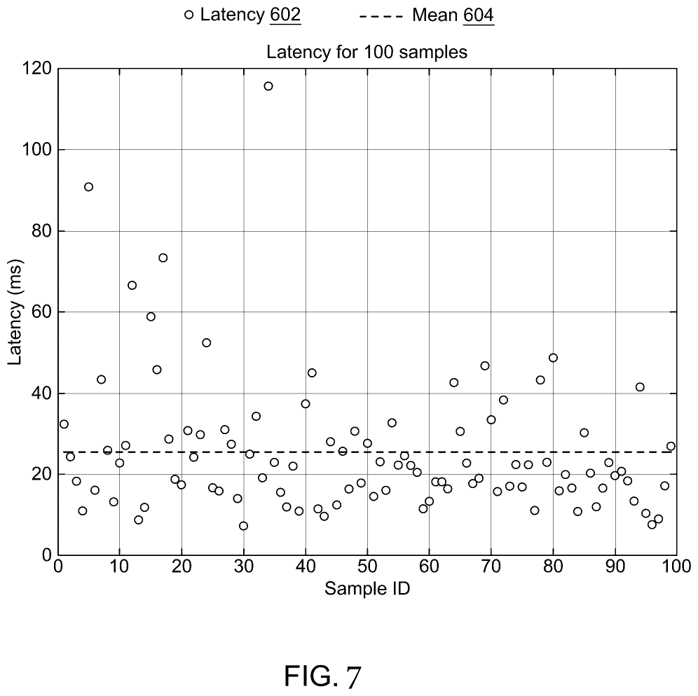

FIG. 7 illustrates a latency profile 600 for 100 samples in a sensor network of the SEM processing circuitry for real-time monitoring of electric loads within a household. The latency profile 600 tracks and reports the latency, measured in milliseconds (ms), for data transmission from the smart meter, functioning as the publisher, to a dedicated central data collection point acting as the subscriber. Each data point represents a unique communication instance between the publisher and subscriber. The graph of latency profile 600 shows individual latency measurements 602 for each sample, alongside a mean latency 604, providing a comprehensive view of the temporal dynamics within the system. The observed latency values range significantly, revealing variations in transmission times for understanding and optimizing the communication efficiency of the SEM processing circuitry.

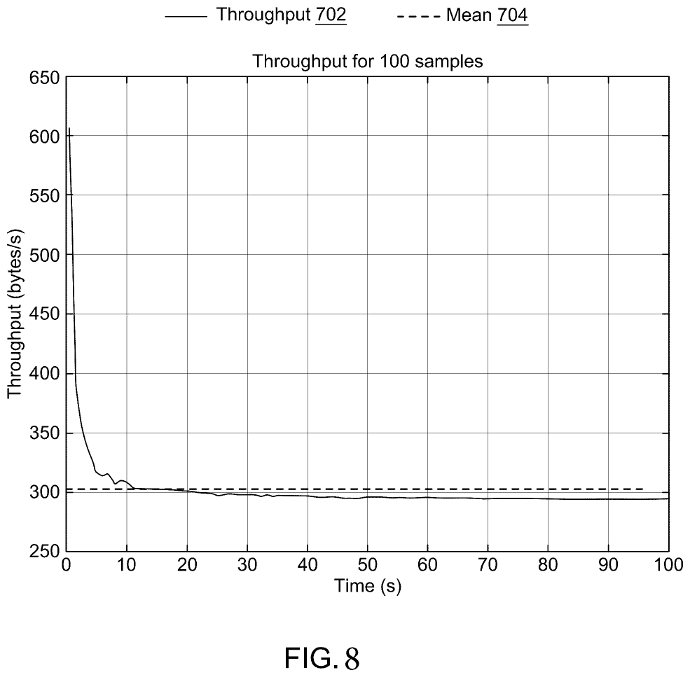

FIG. 8 illustrates a throughput profile 700 for 100 samples in the sensor network of the SEM processing circuitry. The throughput, measured in bytes per second (bytes/s), represents the rate at which data is successfully transmitted from the smart meter to the central data collection point. The throughput curve 702 displays an initial high value that gradually decreases, showing an exponential decay before stabilizing at an asymptotic mean value 704. The throughput profile 700 provides insights into the efficiency and performance of the data transmission processes within the smart grid framework. The consistent decrease in throughput followed by stabilization highlights behavior of the system under continuous data transmission conditions, essential for refining and enhancing communication strategies in smart grid applications.

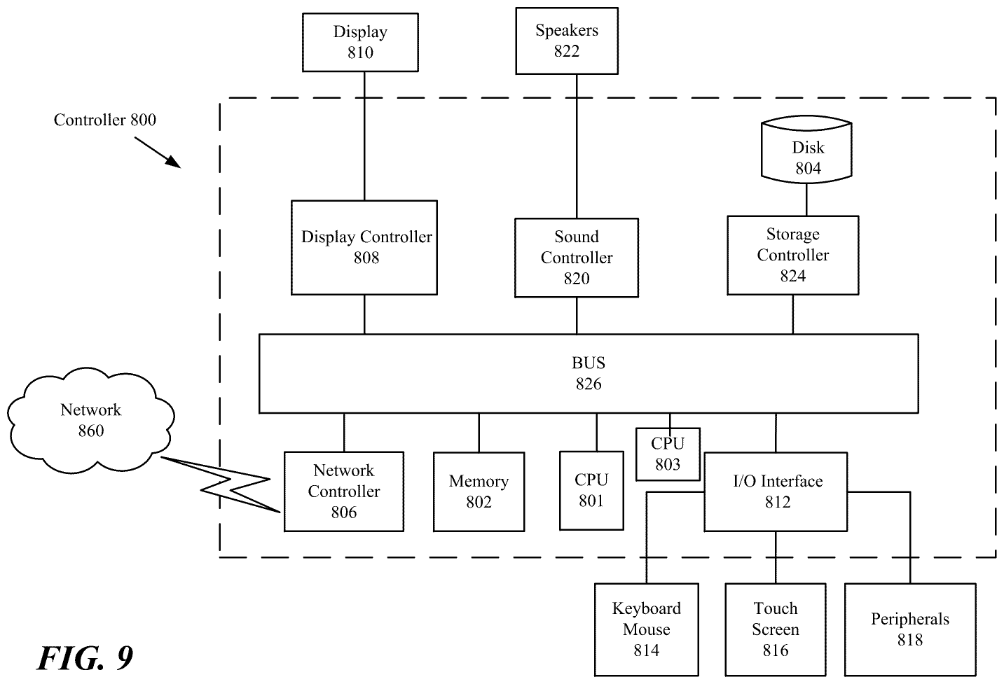

Next, further details of the hardware description of the computing environment of FIG. 4A according to exemplary embodiments is described with reference to FIG. 9. In FIG. 9, a controller 800 is described is representative of the system 450 of FIG. 4A in which the controller is a computing device which includes a CPU 801 which performs the processes described herein. The process data and instructions may be stored in memory 802. These processes and instructions may also be stored on a storage medium disk 804, such as a hard drive (HDD) or portable storage medium or may be stored remotely.

Further, the disclosed computing environment is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the disclosed computing environment may be provided as a utility application, background daemon, or component of an operating system, or combination thereof, executing in conjunction with CPU 801, 803 and an operating system such as Microsoft Windows 7, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 801 or CPU 803 may be a Xenon or Core processor from Intel of America or an Opteron processor from AMD of America, or may be other processor types that would be recognized by one of ordinary skill in the art. Alternatively, the CPU 801, 803 may be implemented on an FPGA, ASIC, PLD or using discrete logic circuits, as one of ordinary skill in the art would recognize. Further, CPU 801, 803 may be implemented as multiple processors cooperatively working in parallel to perform the instructions of the inventive processes described above.

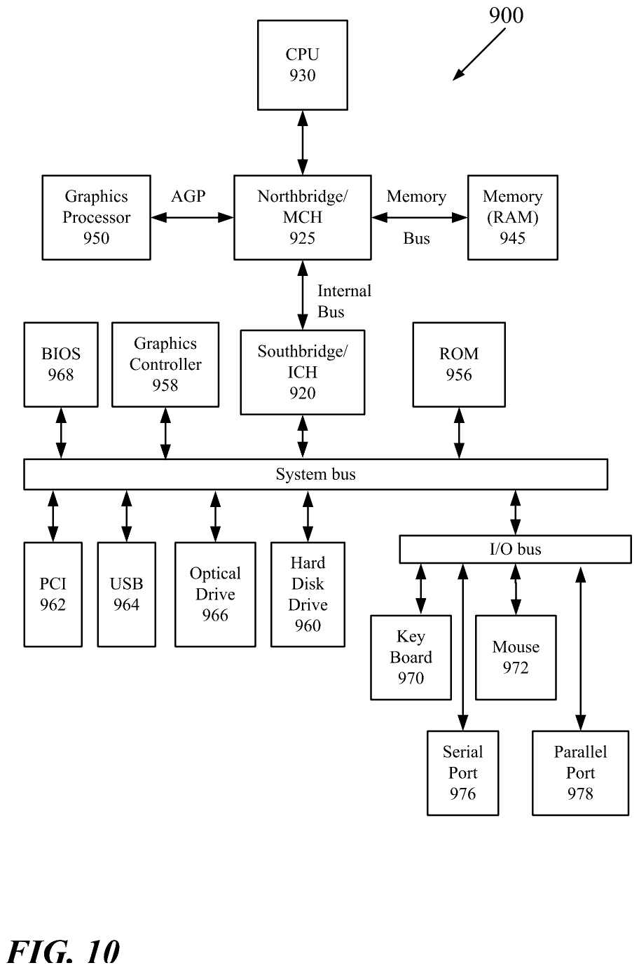

The computing device in FIG. 10 also includes a network controller 906, such as an Intel Ethernet PRO network interface card from Intel Corporation of America, for interfacing with network 960. As can be appreciated, the network 960 can be a public network, such as the Internet, or a private network such as an LAN or WAN network, or any combination thereof and can also include PSTN or ISDN sub-networks. The network 960 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the computing device such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the computing device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

The exemplary circuit elements described in the context of the present disclosure may be replaced with other elements and structured differently than the examples provided herein.

Moreover, circuitry configured to perform features described herein may be implemented in multiple circuit units (e.g., chips), or the features may be combined in circuitry on a single chipset, as shown on FIG. 10.

FIG. 10 shows a schematic diagram of a data processing system, according to certain embodiments, for performing the functions of the exemplary embodiments. The data processing system is an example of a computer in which code or instructions implementing the processes of the illustrative embodiments may be located.

In FIG. 10, data processing system 900 employs a hub architecture including a north bridge and memory controller hub (NB/MCH) 925 and a south bridge and input/output (I/O) controller hub (SB/ICH) 920. The central processing unit (CPU) 930 is connected to NB/MCH 925. The NB/MCH 925 also connects to the memory 945 via a memory bus, and connects to the graphics processor 950 via an accelerated graphics port (AGP). The NB/MCH 925 also connects to the SB/ICH 920 via an internal bus (e.g., a unified media interface or a direct media interface). The CPU Processing unit 930 may contain one or more processors and even may be implemented using one or more heterogeneous processor systems.

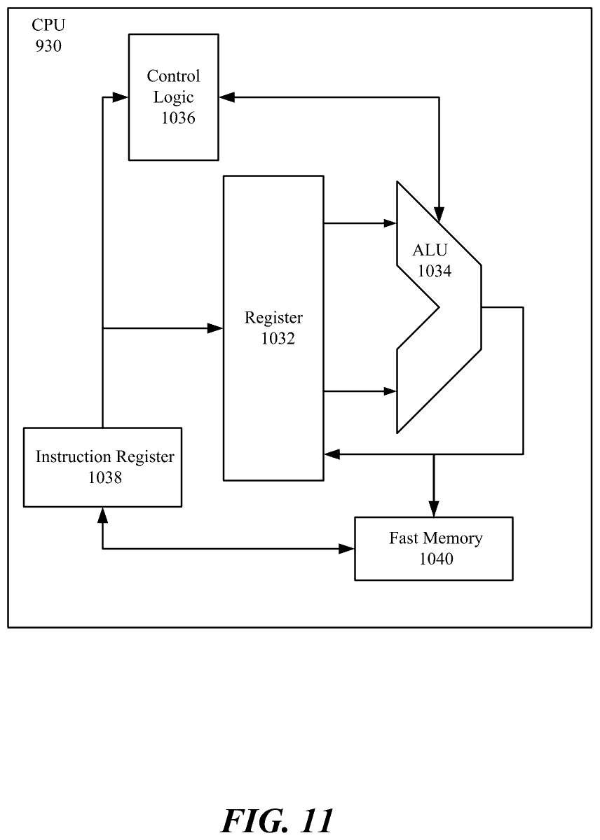

For example, FIG. 11 shows one implementation of CPU 930. In one implementation, the instruction register 1038 retrieves instructions from the fast memory 1040. At least part of these instructions are fetched from the instruction register 1038 by the control logic 1036 and interpreted according to the instruction set architecture of the CPU 930. Part of the instructions can also be directed to the register 1032. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1034 that loads values from the register 1032 and performs logical and mathematical operations on the loaded values according to the instructions. The results from these operations can be feedback into the register and/or stored in the fast memory 1040. According to certain implementations, the instruction set architecture of the CPU 930 can use a reduced instruction set architecture, a complex instruction set architecture, a vector processor architecture, a very large instruction word architecture. Furthermore, the CPU 930 can be based on the Von Neuman model or the Harvard model. The CPU 930 can be a digital signal processor, an FPGA, an ASIC, a PLA, a PLD, or a CPLD. Further, the CPU 930 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 10, the data processing system 900 can include that the SB/ICH 920 is coupled through a system bus to an I/O Bus, a read only memory (ROM) 956, universal serial bus (USB) port 964, a flash binary input/output system (BIOS) 968, and a graphics controller 958. PCI/PCIe devices can also be coupled to SB/ICH 988 through a PCI bus 962.

The PCI devices may include, for example, Ethernet adapters, add-in cards, and PC cards for notebook computers. The Hard disk drive 960 and CD-ROM 966 can use, for example, an integrated drive electronics (IDE) or serial advanced technology attachment (SATA) interface. In one implementation the I/O bus can include a super I/O (SIO) device.

Further, the hard disk drive (HDD) 960 and optical drive 966 can also be coupled to the SB/ICH 920 through a system bus. In one implementation, a keyboard 970, a mouse 972, a parallel port 978, and a serial port 976 can be connected to the system bus through the I/O bus.

Other peripherals and devices that can be connected to the SB/ICH 920 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

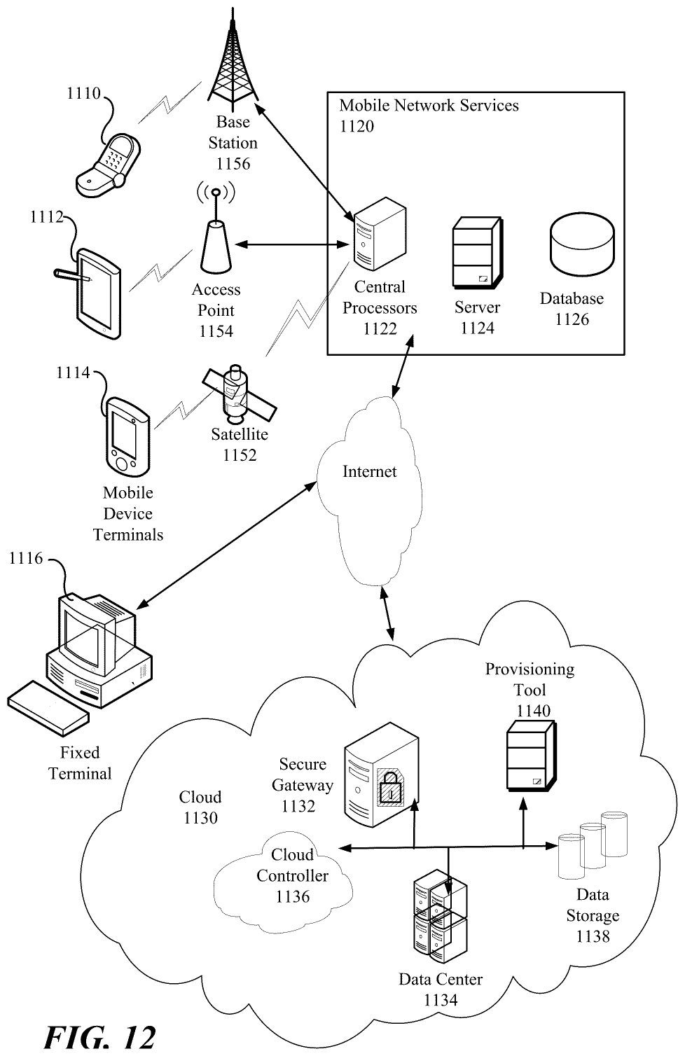

The functions and features described herein may also be executed by various distributed components of a system. For example, one or more processors may execute these system functions, wherein the processors are distributed across multiple components communicating in a network. The distributed components may include one or more client 1116 and server machines 1122, 1124, which may share processing, as shown by FIG. 12, in addition to various human interface and communication devices (e.g., cellular phones 1110 via base station 1156, smart phones 1114 via satellite 1152, tablets 1112 via access point 1154, personal digital assistants (PDAs) via mobile network services 1120 and database 1126). The network may be a private network, such as a LAN or WAN, or may be a public network, such as the Internet (Cloud 1130, secure gateway 1132, data center 1134, cloud controller 1136, data storage 1138, provisioning tool 1140). Input to the system may be received via direct user input and received remotely either in real-time or as a batch process. Additionally, some implementations may be performed on modules or hardware not identical to those described. Accordingly, other implementations are within the scope of the disclosure.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A sensor network of Smart Electricity Meter (SEM) processing circuitry for real-time monitoring of electric loads within a household, comprising
a plurality of SEM processing boards mounted adjacent to electrical outlets of the household;
a plurality of electrical appliances in the household, each appliance connected as a publisher to one SEM processing board of the plurality of SEM processing boards, wherein each SEM processing board is configured to receive an actuator command for a respective electrical appliance of the plurality of electrical appliances; and
at least one subscriber processing circuitry mounted at a location in the household, wherein the subscriber processing circuitry is configured to subscribe to a topic for sensor data of one electrical appliance of the plurality of electrical appliances and perform data storage of the sensor data in a storage device and analyze the sensor data to monitor electrical load of the electrical appliance,
wherein each SEM processing board is configured to periodically monitor sensor data from an electrical appliance of the plurality of electrical appliances and, when there is a change in the sensor data, publish the sensor data for the topic to an intermediate agent of a Data Distribution Service (DDS) processing circuitry mounted at a centralized location in the household,
wherein the intermediate agent receives and stores the published sensor data for the topic, and
wherein the intermediate agent is configured to control transmission of the sensor data for the topic to the at least one subscriber processing circuitry that subscribes to the topic.

2. The sensor network of claim 1, wherein each SEM processing board is encapsulated in an insulated container having an external facing electrical outlet and inward facing electrical prongs that are pluggable into a respective electrical outlet and a respective electrical appliance is connected to the SEM processing board by a power connector,
wherein each SEM processing board includes at least one micro-meter to measure power consumption of the respective electrical appliance,
wherein each SEM processing board is programmable and configured to detect, monitor and control the respective electrical appliance.

3. The sensor network of claim 2, wherein the at least one micro-meter includes a current sensor and an analog-to-digital converter (ADC), positioned in series with the respective electrical appliance, wherein the current sensor is configured to measure analog current, and the ADC is configured to convert the analog current to a digital current signal.

4. The sensor network of claim 3, wherein each SEM processing board includes a microcontroller and a wireless communication device configured to read the digital current signal and either transmit the current reading to a user device or use the digital current signal to make an electrical load decision.

5. The sensor network of claim 4, wherein the microcontroller is configured with program instructions to collect the digital current signal and calculate actual power usage.

6. The sensor network of claim 4, wherein the microcontroller is configured to make a decision to cut off power supply to a respective electrical appliance through an actuator command.

7. The sensor network of claim 4, further comprising a remote user device, wherein the microcontroller is configured with a transceiver to receive instructions from the remote user device or transmit sensor data to the remote user device.

8. The sensor network of claim 1, wherein the sensor data is stored for a plurality of topics including current, voltage, frequency, and temperature, wherein the subscriber processing circuitry is configured to request sensor data by a particular topic.

9. The sensor network of claim 1, wherein each of the SEM processing board is configured to publish sensor data to the intermediate agent in real time, in which the subscriber processing circuitry includes a shared database for storing subscribed sensor data for the household.

10. The sensor network of claim 1, wherein the intermediate agent is configured to receive each published sensor data and transmits the published sensor data for the topic to the subscriber processing circuitry that subscribes to the topic, wherein the intermediate agent is configured to manage communication functions of the DDS.

11. A method of real-time monitoring of electric loads of a plurality of electrical appliances within a household, each of the plurality of electrical appliances connected as a publisher to one Smart Electricity Meter (SEM) processing board of a plurality of SEM processing boards which are mounted adjacent to electrical outlets in the household, comprising:
periodically monitoring respective sensor data from one electrical appliance of the plurality of electrical appliances and, when there is a change to sensor data, publishing, by the respective SEM processing board, the sensor data for a topic to an intermediate agent of a Data Distribution Service (DDS) processing circuitry, which is mounted at a centralized location in the household;
subscribing, by at least one subscriber processing circuitry mounted in the household, to the topic for the sensor data of specific electrical appliances of the household;
control transmission, by the intermediate agent, of the sensor data for the topic to the at least one subscriber processing circuitry that subscribes to the topic;
performing, by the subscriber processing circuitry, data storage of the sensor data in a storage device and analysis on the sensor data to monitor electric load of the one electrical appliance; and
actuating an actuator upon receiving a respective appliance specific actuator command for the one electrical appliance based on the analysis of the sensor data.
12. The method of claim 11, further comprising measuring, by a micro-meter, power consumption of the one electrical appliance; and
programming and configuring the SEM processing board to detect, monitor and control the one electrical appliance.

13. The method of claim 12, further comprising:
measuring, by a current sensor, analog current of the respective electrical appliance; and
converting the analog current to a digital current signal using an analog-to-digital converter (ADC).

14. The method of claim 13, further comprising reading, by a microcontroller, the digital current signal and either transmitting the current reading to a user device or using the digital current signal to an make an electrical load decision.

15. The method of claim 14, further comprising:
collecting, by the microcontroller, the digital current signal; and
calculating actual power usage of the respective electrical appliance.

16. The method of claim 14, further comprising making, by the microcontroller, a decision to cut off power supply to the respective electrical appliance through an actuator command.

17. The method of claim 14, further comprising receiving, by the microcontroller, instructions from a remote user device or transmitting the sensor data to the remote user device.

18. The method of claim 11, further comprising storing the sensor data for a plurality of topics including current, voltage, frequency, and temperature; requesting, by the subscriber processing circuitry, sensor data by a particular topic.

19. The method of claim 11, further comprising:
publishing, by the SEM processing board, sensor data to the intermediate agent in real time; and
storing, by the subscriber processing circuitry, in a shared database subscribed sensor data for the household.

20. The method of claim 11, wherein the intermediate agent manages communication functions of the DDS, the method further comprising:
receiving, by the intermediate agent, each published sensor data; and
transmitting, by the intermediate agent, the published sensor data for the topic to the subscriber processing circuitry that subscribes to the topic.
